(19) United States
(12) Patent Application Publication
(10) Pub. No.: US 2026/0055313 A1
(43) Pub. Date: Feb. 26, 2026

(54) INVERT EMULSION DRILLING FLUID

(71) Applicant: Schlumberger Technology Corporation, Sugar Land, TX (US)

(72) Inventors: Justin Linscombe, Houston, TX (US); Adrian Morales, Houston, TX (US)

(21) Appl. No.: 18/810,125

(22) Filed: Aug. 20, 2024

(51) Int. Cl. C09K 8/36

(52) U.S. Cl. CPC C09K 8/36

(57) ABSTRACT

The present disclosure provides drilling fluids including emulsions. The emulsions include an aqueous phase, an oil, an emulsifier composition, and a wetting agent. The emulsifier composition includes an amidoamine. The wetting agent includes a first organic acid. The first organic acid selected from the group consisting of C₆-C₃₀ carboxylic acid, C₆-C₃₀ alkeynl acid, C₆-C₃₀ arylakyl acid, and a C₆-C₃₀ cycloalkyl acid. The wetting agent includes an alcohol alkoxylate. A ratio of the oil to the aqueous phase is about 85:15 to about 60:40 of the oil to the aqueous phase

### FIELD

This application relates to stable emulsions used as drilling fluids. More specifically, this application relates to methods and compositions for stabilizing invert, emulsions, e.g., water-in-oil, in drilling geologic formations.

### BACKGROUND

During wellbore operations, various fluids may be used in the well for a variety of functions. The fluids may be circulated through a bore hole, which may subsequently flow upward through the wellbore to the surface. During this circulation, the drilling fluid may remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Wellbore fluids may take the form of oil-based fluids such as invert emulsion muds. The components of the invert emulsion fluids include an oil such as hydrocarbon oil which serves as a continuous phase, a an aqueous phase such as water or brine solution which serves as a discontinuous phase, and an emulsifier. Emulsifying agents may be used to lower the interfacial tension of the liquids so that the aqueous phase may form a stable dispersion of fine droplets in the oil.

Such invert emulsion fluids may contain one or more weighting agents, surfactants, viscosifiers, fluid loss control agents or bridging agents. Conventionally, such invert emulsion fluids take the form of a “mud”, e.g., a liquid having solids suspended therein. The solids function to impart desired rheological properties to the drilling fluid and also to increase the density thereof in order to provide a suitable hydrostatic pressure at the bottom of the well. Unfortunately, the solids, such as clays, increase the pressure downhole, thereby increasing mechanical washout or erosion tendency of oilfield tubulars downhole or pumping equipment on the surface of the wellbore.

Accordingly, there is a need for improved direct emulsion drilling fluids.

### SUMMARY

In an embodiment, the present disclosure provides drilling fluids including an emulsion. The emulsion includes an aqueous phase. The emulsion includes an oil. The emulsion includes an emulsifier composition. The emulsifier composition includes an amidoamine. The emulsion includes a wetting agent. The wetting agent includes a first organic acid. The first organic acid selected from the group consisting of C₆-C₃₀ carboxylic acid, C₆-C₃₀ alkeynl acid, C₆-C₃₀ arylakyl acid, and a C₆-C₃₀ cycloalkyl acid. The wetting agent includes an alcohol alkoxylate. A ratio of the oil to the aqueous phase is about 85:15 to about 60:40 of the oil to the aqueous phase.

In another embodiment, the present disclosure provides drilling fluids including an emulsion. The emulsion includes an aqueous phase. The emulsion includes an oil. The emulsion includes a solid fluid loss control agent. The emulsion includes an emulsifier composition. The emulsifier composition includes an amidoamine. The emulsion includes a wetting agent. The wetting agent includes a first organic acid. A ratio of the oil to the aqueous phase is about 85:15 to about 60:40 of the oil to the aqueous phase.

In another embodiment, the present disclosure provides drilling fluids including an emulsion. The emulsion includes an aqueous phase. The emulsion includes an oil. The emulsion includes a liquid fluid loss control agent. The emulsion includes an emulsifier composition. The emulsifier composition includes an amidoamine. The emulsion includes a wetting agent. The wetting agent includes a first organic acid. A ratio of the oil to the aqueous phase is about 85:15 to about 60:40 of the oil to the aqueous phase.

### BRIEF DESCRIPTION OF THE DRAWINGS

FIGS. 1A and 1B shows schematic filtrate volumes and cake thicknesses of an invert emulsion having no clay, according to embodiments of the present disclosure.

FIGS. 2A and 2B shows schematic filtrate volumes and cake thicknesses of an invert emulsion having no solids, according to embodiments of the present disclosure.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Described herein are invert emulsion drilling fluids utilizing diesel or a synthetic base oil as the oil, and brine as the aqueous phase with drilling fluid additives that are liquid and/or soluble. The invert emulsion drilling fluids can include weighting agents in a solid form, e.g., barite. The invert emulsion includes no solid or un-soluble drilling fluid additives, e.g., gilsonite, calcium carbonate, asphaltene, or non-naturally occurring clay components, e.g., hydrophilic clays, organophilic clays, or the like. For example, no clays such as treated or untreated bentonite, treated or untreated smectite, treated or untreated sepiolite, and/or treated or untreated kaolinite are included in the invert emulsion drilling fluid.

The invert emulsion drilling fluids of the present disclosure include a stable and optimal rheology for the suspension of weighting material as well as hole cleaning without the use of any clay-based materials and/or insoluble solid components. Elimination of clay-based materials and/or insoluble solid components provides an invert emulsion drilling fluid having reduced pressure downhole, thereby reducing mechanical washout and/or erosion tendency of oilfield tubulars downhole and/or pumping equipment on the surface.

The invert emulsion drilling fluids of the present disclosure include an optimal rheology having stability by introducing an amidoamine emulsifier composition and a wetting agent having a first organic acid selected from the group consisting of C₆-C₃₀ carboxylic acid, C₆-C₃₀ alkeynl acid, C₆-C₃₀ arylakyl acid, and a C₆-C₃₀ cycloalkyl acid, and an alcohol alkoxylate, to a mixture of an aqueous phase and oil. The invert emulsion drilling fluid can clean a well while drilling while still suspending weighting agents. Moreover, the invert emulsion drilling fluid includes a controllable rheology due to the adjustment of the oil-aqueous phase ratio and/or a non-clay based rheology modifier such as gilsonite, in which increasing the oil-aqueous phase ratio can reduce the rheology while decreasing the oil-aqueous phase ratio can increase the rheology. The invert emulsion drilling fluid can include an oil-aqueous phase ratio of about 85:15 vol/vol % to about 60:40 vol/vol %. Additionally, the invert emulsion drilling fluid of the present disclosure includes enhanced stability due to one or more C₂-C₁₀ fatty acid ether.

### Drilling Fluid

The drilling fluid of the present disclosure includes an emulsion. The emulsion includes an invert emulsion drilling fluid having an oil and an aqueous phase dispersed within the oil. The oil can include a synthetic or non-synthetic organic fluid, e.g., diesel, The aqueous phase includes water, brine, ionic solutions, or a combination thereof. The aqueous phase can include pure water, brine up to saturation, ionic solutions, or a combination thereof. The aqueous phase can include alkali metal halide salts, alkali metal salts with small organic anions, and alkali metal salts with inorganic anions such as sulfate, phosphate, and nitrate. The aqueous phase can include about 15 wt % to about 30 wt % of the alkali metal halide salts, alkali metal salts with small organic anions, and alkali metal salts with inorganic anions, e.g., about 15 wt % to about 25 wt % or about 20 wt % to about 25 wt % of calcium chloride.

The invert emulsion includes a ratio of the oil to the aqueous phase is about 85:15 vol/vol % to about 60:40 vol/vol % of the oil to the aqueous phase. For example, the invert emulsion includes a ratio of the oil to the aqueous phase of about 80:20 to about 70:30, about 75:25 to about 70:30, or about 73:17 to about 70:30. Without being bound by theory, an oil to aqueous phase ratio of about 85:15 vol/vol % to about 60:40 vol/vol % allows for an enhanced control of the density and rheology profile of the invert emulsion fluid to be established compared to conventional invert emulsion drilling fluids. Additionally, and without being bound by theory, the enhanced control of the density and rheology profile allows for reducing and/or eliminating solids and/or clay in the invert emulsion drilling fluid while maintaining sufficient rheology for cleaning the wellbore and the suspension of weighting agents in the invert emulsion drilling fluid.

The aqueous phase is dispersed within the oil as an invert emulsion. Additionally, an emulsifier composition is dispersed within the emulsion, thereby stabilizing the oil and aqueous phase to maintain a dispersion. The emulsifier composition can include an amidoamine. Amidoamines may include one or more compounds formed from a reaction of a fatty acid, C₆-C₃₀ fatty acids such as lauric acid, myristic acid, palmitic acid, stearic acid, oleic acid, linoleic acid, tall oil or fatty acids (TOFA); C₆-C₃₀ alkenyl acids, C₆-C₃₀ arylalkyl acids, C₆-C₃₀ cycloalkyl acid, and a polyamine, e.g., linear or branched organophilic C₆-C₃₆ fatty polyamines including polyaliphatic polyamines, heterocyclic polyamines, or a combination thereof. For example, polyamines may include polyethylene polyamines such as diethylene triamine, triethylene tetramine, and tetraethylene pentamine.

The emulsifier composition include an organic acid selected from the group consisting of C₆-C₃₀ carboxylic acid, C₆-C₃₀ alkeynl acid, C₆-C₃₀ arylakyl acid, and a C₆-C₃₀ cycloalkyl acid. The emulsifier composition can include an organic acid dimer and/or trimer. For example, the organic acid dimer and/or trimer can include a dimer and/or trimer of an organic acid selected from the group consisting of C₆-C₃₀ carboxylic acid, C₆-C₃₀ alkeynl acid, C₆-C₃₀ arylakyl acid, and a C₆-C₃₀ cycloalkyl acid. The emulsifier composition can include an alkyl ether, e.g., glycol ether. The emulsifier composition can include a paraffin. In some embodiments, which can be combined with other embodiments, the emulsifier composition can include about 40 wt % to about 60 wt % amidoamine, about 10 wt % to about 40 wt % organic acid, about 1 wt % to about 10 wt % alkyl ether, and about 20 wt % to about 30 wt % paraffin. Exemplary emulsifiers in accordance with the present disclosure may include RheMul™ and SUREMUL™, which are commercially available emulsifiers manufactured and distributed by M-I, L.L.C.

A wetting agent is dispersed within the emulsion. The wetting agent includes an organic acid. The organic acid is a C₆-C₃₀ carboxylic acid having a formula represented by:

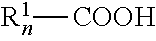

wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof; and n is an integer of 1 to 6. For example, R¹ can include lauric acid, myrstic acid, palmitic acid, stearic acid, oleic acid, linoleic acid, tall oil or fatty acids (TOFA), of a combination thereof, and n is an integer of 1. In some embodiments, R¹ can is an oleic acid and n is an integer of 1.

The wetting agent includes an alcohol alkoxylate. The alcohol alkoxylate can include a formula represented by:

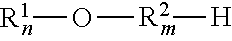

wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof; R² is an C₁-C₃ alkoxy; n is an integer of 1 to 6; and m is an integer of 1 to 6. For example, R¹ is a linear or branched carbon chain including a substituted or unsubstituted C₈-C₂₂ alkyl, and R² is an ethylene oxide, n is 1, and m is 1. As a further example, R¹ is a linear or branched carbon chain including a substituted or unsubstituted C₈-C₂₂ alkyl, and R² is a propylene oxide, n is 1, and m is 1.

In some embodiments, a combination of ethoxylation and propoxylation may be used. For example, m may be 2, in which a first R² is an ethylene oxide and a second R² is a propylene oxide. As a further example, m may be 2, in which a first R² is a propylene oxide and a second R² is an ethylene oxide.

In some embodiments, the alcohol alkoxylate is a primary alcohol alkoxylate where R¹ is an oleyl group, a stearyl group, a tridecyl group, or a lauryl group. In some embodiments, R² is an ethylene oxide or a propylene oxide. In one or more embodiments, the wetting agent may be at least one alcohol ethoxylate selected from group of oleyl alcohol-2-ethyoxylate, oleyl alcohol-3-ethyoxylate, oleyl alcohol-5-ethyoxylate, stearyl alcohol-2-ethyoxylate, stearyl alcohol-3-ethyoxylate, lauryl alcohol-4-ethyoxylate, and tridecyl alcohol-3-ethyoxylate.

In some embodiments, the alcohol alkoxylate is a secondary alcohol alkoxylate where R¹ is branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof. For example, the secondary alcohol alkoxylate can include octyl alcohol ethoxylate, caprylic alcohol ethoxylate, decyl alcohol ethoxylate, lauryl alcohol, oleyl alcohol ethoxylate, oleyl alcohol-3 ethoxylate, palmitoleic alcohol ethoxylate, isostearyl alcohol ethoxylate, octyl dodecanol ethoxylate, octyl decanol ethoxylate, equivalent propylated and iso-propylated derivatives, and the like. FAZEWET™, RHECON™, VERSACOAT™ SUREWET™, VERSAWET™, RHECON™, MEGAMUL™, SUREMUL™, ONEMUL™ ACTIMUL RD™, MUL-XT™, and VERSAWET™ NS are examples of commercially available wetting agents manufactured and distributed by M-I L.L.C. that may be used in the fluids disclosed herein.

The invert emulsion drilling fluid can include a solid fluid loss control agent. The solid fluid loss control agent can include a non-clay based solid fluid loss control agent, e.g., a solid fluid loss control agent that does not include non-naturally occurring clay components, e.g., hydrophilic clays, organophilic clays, or the like. The non-clay based solid fluid loss control agent can include a naturally occurring organic material such as gilsonite. The solid fluid loss control agent does not include clays such as treated or untreated bentonite, treated or untreated smectite, treated or untreated sepiolite, and/or treated or untreated kaolinite.

The invert emulsion drilling fluid can include a liquid fluid loss control additive. The liquid fluid loss control additive can include a C₂-C₁₀ fatty acid ether. For example, the liquid fluid loss control additive can include a glycol ether such as a propylene glycol ether. The propylene glycol ether can include dipropylene glycol methyl ether. In some embodiments, the fluid loss control additive can include rosin. For example, the liquid fluid loss control additive can include about 10 wt % to about 90 wt % of the C₂-C₁₀ fatty acid ether and about 0 wt % to about 20 wt % of rosin.

The rheology modifier can include a liquid based rheology modifier, e.g., a rheology modifier that is soluble and/or miscible with the invert emulsion drilling fluid. In some embodiments, the non-clay based rheology modifier can include a fatty acid, fatty acid dimer, fatty acid trimer, and/or a polymer with diethanolamine and/or diethylentriamine. In some embodiments, the fatty acid can include C₆-C₃₀ fatty acids such as lauric acid, myristic acid, palmitic acid, stearic acid, oleic acid, linoleic acid, tall oil or fatty acids (TOFA); C₆-C₃₀ alkenyl acids, C₆-C₃₀ arylalkyl acids, and/or C₆-C₃₀ cycloalkyl acids. The fatty acid dimer can include a dimer of C₆-C₃₀ fatty acids such as lauric acid, myristic acid, palmitic acid, stearic acid, oleic acid, linoleic acid, tall oil or fatty acids (TOFA); C₆-C₃₀ alkenyl acids, C₆-C₃₀ arylalkyl acids, and/or C₆-C₃₀ cycloalkyl acids. The fatty acid trimer can include a trimer of C₆-C₃₀ fatty acids such as lauric acid, myristic acid, palmitic acid, stearic acid, oleic acid, linoleic acid, tall oil or fatty acids (TOFA); C₆-C₃₀ alkenyl acids, C₆-C₃₀ arylalkyl acids, and/or C₆-C₃₀ cycloalkyl acids. Without being bound by theory, where the rheology modifier is a liquid based rheology modifier the invert emulsion drilling fluid may be substantially free of solids and/or un-soluble drilling fluid additives, e.g., gilsonite, calcium carbonate, and/or asphaltene, such that a further reduction of downhole pressure is achieved due to the lack of solids present in the invert emulsion drilling fluid.

The invert emulsion drilling fluid can include a weighting agent. The weighting agent can include hematite, magnetite, iron oxides, illmenite, barite, siderite, celestite, dolomite, calcite, manganese oxides, halites, or a combination thereof. In one or more embodiments, weighting agents may have a weight average particle diameter (d50) in a range having a lower limit selected from any one of 0.5 μm, 1 μm, 2 μm, and 5 μm, to an upper limit selected from any one of 3 μm, 6 μm, 8 μm, and 10 μm, where any lower limit may be combined with any upper limit. In some embodiments, the weighting agents may have a weight average particle diameter (d50) in a range of 6 μm to 8 μm.

In some embodiments, the invert emulsion drilling fluid includes about 5 pounds per barrel (lbs/bbl) to about 12 lbs/bbl of the emulsifier composition; about 1 lbs/bbl to about 4 lbs/bbl of the wetting agent; and about 1 lbs/bbl to about 6 lbs/bbl of the solid fluid loss control agent. In some embodiments, the invert emulsion drilling fluid includes about 5 pounds per barrel (lbs/bbl) to about 12 lbs/bbl of the emulsifier composition; about 1 lbs/bbl to about 4 lbs/bbl of the wetting agent; and about 1 lbs/bbl to about 8 lbs/bbl of the liquid fluid loss control additive.

In some embodiments, invert emulsion drilling fluid includes a yield point of about 0.8 to about 1.5 times the fluid density after hot rolling and/or while drilling. For example, the invert emulsion drilling fluid includes a yield point of about 10 lbf/1000 ft³ to about 18 lbf/1000 ft³, where a fluid density is about 12.5 pounds per gallon (ppg). Without being bound by theory, the non-clay and/or solids free invert emulsion drilling fluid of the present disclosure having a yield point of about 10 lbf/1000 ft³ to about 18 lbf/1000 ft³ while having a density of about 12.5 ppg can suspend and remove drilled solids while maintaining reduced downhole pressures compared to conventional invert emulsion drilling fluids, thereby reducing and/or eliminating mechanical washout and/or erosion tendency downhole or in the pumping equipment on the surface.

In some embodiments, invert emulsion drilling fluid includes a water in high temperature, e.g., greater than 250° F., and high pressure, e.g., greater than 500 psi pressure differential, of about 0.0 mL before or after hot rolling and/or while drilling. Without being bound by theory, the non-clay and/or solids free invert emulsion drilling fluid of the present disclosure having a water content in high temperature and high pressure of about 0.0 mL may indicate a stable invert emulsion drilling fluid having no clay and/or solids compared to conventional invert emulsion drilling fluids, which have clays and/or solids. Additionally, and without being bound by theory, a stable invert emulsion drilling fluid having no clay and/or solids can reduce and/or eliminate mechanical washout and/or erosion tendency downhole or in the pumping equipment on the surface.

### EXAMPLES

### Example 1

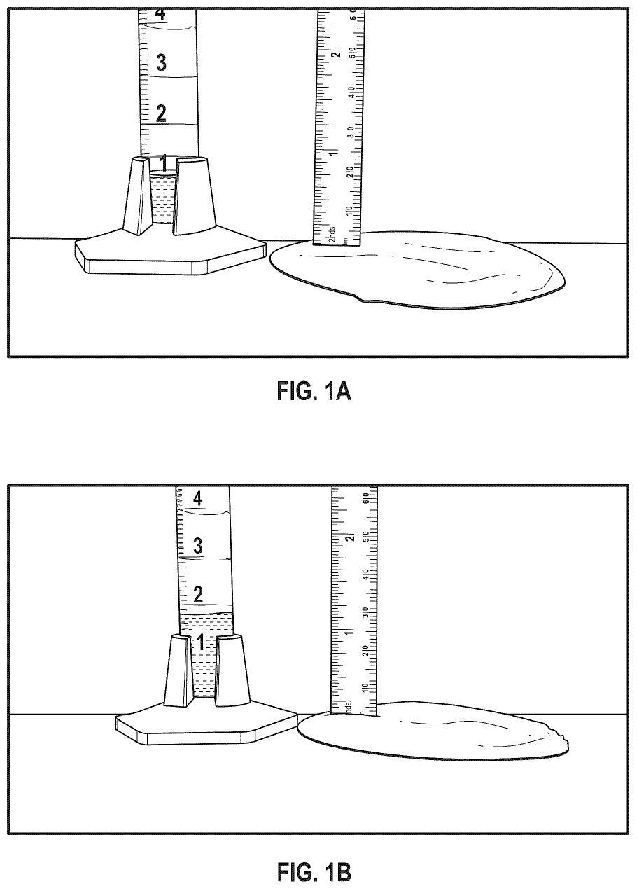

Now referring to FIG. 1A and FIG. 1B, an invert emulsion drilling fluid having a no clay additives is shown. An invert emulsion drilling fluid was formulated having about a 70:30 vol/vol % ratio of diesel to brine solution, e.g., 24 wt % CaCl₂ in water. The invert emulsion drilling fluid included about 2 to about 10 lb/bbl of lime, about 5 to about 12 lb/bbl of an emulsifier composition comprising about 45 to about 65 wt % amidoamine, about 10 wt % to about 40 wt % fatty acid, about 2 wt % to about 10 wt % fatty acid dimer, about 5 wt to about 15 wt % glycol ether, and about 20 wt % to about 30 wt % paraffin. The invert emulsion drilling fluid included about 1 to about 4 lb/bbl of a wetting agent including a fatty acid. The invert emulsion drilling fluid included about 1 lb/bbl to about 6 lb/bbl of a solid fluid loss control agent including ground gilsonite and about 0 lb/bbl to about 2 lb/bbl of a rheology modifier including a fatty acid, fatty acid dimer, and a polymer with diethanolamine and diethylenetriamine. The invert emulsion drilling fluid included a weighting agent as needed to adjust the density of the invert emulsion drilling fluid. The invert emulsion drilling fluid was formulated as shown in Table 1.

TABLE 1

| Compound | Concentration | |
|---|---|---|
| Diesel | 70 | vol % |
| Lime | 2-10 | lb/bbl |
| Emulsifier Composition | 5-12 | lb/bbl |
| Wetting Agent | 1-4 | lb/bbl |
| Water | 30 | vol % |
| 20-25% WT CaCl2 Brine, | | |
| Weighting Agent | As Needed | |
| Fluid Loss Control Agent | 1-6 | lb/bbl |
| Rheology Modifier | 0-2 | lb/bbl |

The rheological properties were measured according to API 13B-2, as shown in Table 2, before heat rolling (Sample 1) and after heat rolling at 200° F. (Sample 2). Fluid tested as per API 13-B2. NAF Solids Analysis is calculated off Diesel 0.835 SG, HDS 4.1 SG, LGS 2.6 SG.

TABLE 2

| Property | Sample 1 | Sample 2 |
|---|---|---|
| Density, pounds per gallon (ppg) | 12.5 at | 12.4 at |
| | 83° F. | 84° F. |
| Rheology Temp, ° F. | 150.00 | 150.00 |
| 600 RPM/300 RPM | 72/44 | 42/29 |
| 200 RPM/100 RPM | 31/20 | 2/19 |
| 6 RPm/3 RPM | 9/7 | 11/10 |
| Plastic Viscosity (PV), centipoise (cP) | 28 | 13 |
| Yield Point (YP), lbf/100 ft² | 16 | 16 |
| Low Shear Yield Point (LSYP), lb/100 ft² | 5 | 9 |
| 10-sec Gel, lb/100 ft² | 17 | 10 |
| 10-min Gel, lb/100 ft² | 17 | 11 |
| 30-min Gel, lb/100 ft² | 17 | 12 |
| Electrical Stability (E.S.) Temp, ° F. | 120.00 | 120.00 |
| E.S., V | 520.5 | 427.5 |
| High Temperature High Pressure Fluid | 250.00 | 250.00 |
| Loss (HTHP FL) Temp, ° F. | | |
| HTHP Fluid Loss, mL | 1.8 | 3.4 |
| Water in HTHP FL, mL | 0.0 | 0.0 |
| Cake Thickness, 1/32″ | 2.00 | 4.00 |
| Phenolphthaleain of Mud (Pom), mL | 2.65 | 1.85 |
| Excess Lime, ppb | 3.445 | 2.405 |
| Solids, wt % | 20.00 | 20.00 |
| Oil, vol % | 57.50 | 58.00 |
| Water vol % | 22.50 | 22.00 |
| Oil:Aqueous Phase Ratio | 71.9/28.1 | 72.5/27.5 |
| Corrected Solids, vol % | 17.99 | 18.03 |
| Low Gravity Solids (LGS), vol % | 1.59 | 2.34 |
| LGS, lb/bbl | 14.498 | 21.295 |
| High Gravity Solids (HGS), vol % | 16.40 | 15.69 |
| HGS, lb/bbl | 235.664 | 225.504 |
| Chlorides (Cl⁻), whole mud, mg/L | 50,500.00 | 49,500.00 |
| Calcium Chloride (CaCl₂), wt % | 25.99 | 26.04 |
| Aqueous (Aqs) Phase Cl⁻, milligrams | 206,091.60 | 206,552.17 |
| per liter (mg/L) | | |
| Aqs Phase CaCl₂, ppm | 259,940.8 | 260,416.7 |

Each of sample 1 and sample 2 had a fluid density after hot roll and/or while drilling of less than 3 times the plastic viscosity, e.g., R600/R300, thereby indicating a similar density to conventional invert emulsion drilling fluids, which have solid fluid additives. Additionally, each of sample 1 and 2 included a yield point of about 0.8 to about 1.5 times the density after the hot rolling and/or while drilling, thereby indicating capability to suspend drill cuttings while drilling. Each of samples 1 and 2 had a LSYP of greater than or equal to 3 lb/100 ft², thereby indicating a reduced risk of weighting agent sag and a high probability of wellbore cleaning while drilling, compared to conventional drilling fluids. A high temperature high pressure fluid loss at 250° F. was about 1.8 mL for sample 1, and about 3.4 for sample 2, as shown in FIGS. 1A and 1B, thereby indicating reduced instability of a wellbore while drilling, compared to conventional drilling fluids. The filter cake thickness of sample 1 was about 1/16″ and the filter cake thickness of sample 2 was about ⅛″, as shown in FIGS. 1A and 1B, thereby indicating a reduced risk of the drill string or casing/liner string being stuck in the wellbore. Each of samples 1 and 2 included about 0 mL of water in the high temperature high pressure filtrate at 250° F., thereby indicating stability of the invert emulsion drilling fluid.

### Example 2

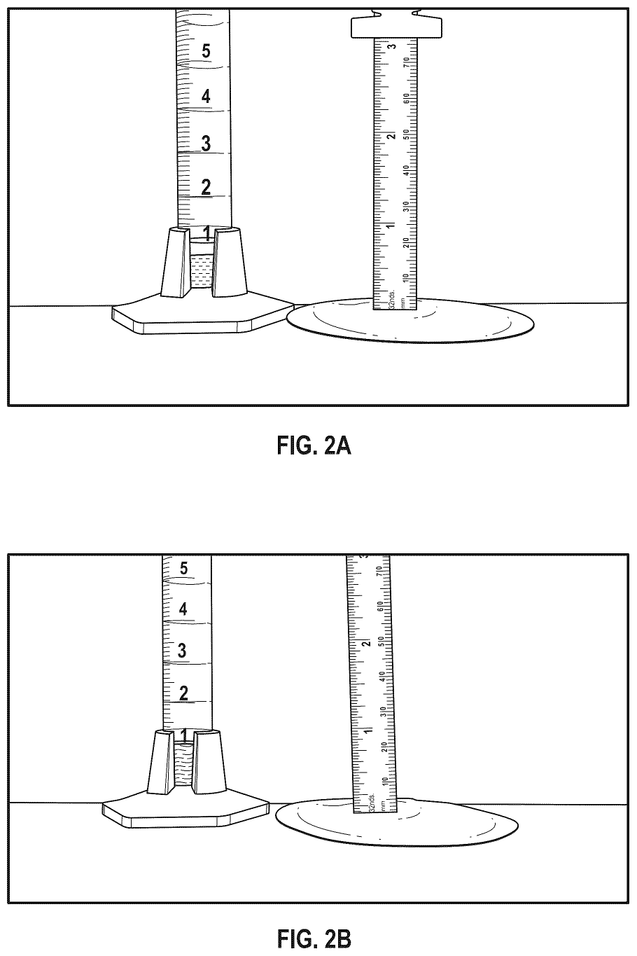

Now referring to FIG. 2A and FIG. 2B, an invert emulsion drilling fluid having a no solid additives, except for the weighting agent, is shown. An invert emulsion drilling fluid was formulated having about a 70:30 vol/vol % ratio of diesel to brine solution, e.g., about 26 wt % CaCl₂ in water. The invert emulsion drilling fluid included about 2 to about 10 lb/bbl of lime, about 5 to about 12 lb/bbl of an emulsifier composition comprising about 45 to about 65 wt % amidoamine, about 10 wt % to about 40 wt % fatty acid, about 2 wt % to about 10 wt % fatty acid dimer, about 5 wt to about 15 wt % glycol ether, and about 20 wt % to about 30 wt % paraffin. The invert emulsion drilling fluid included about 1 to about 4 lb/bbl of a wetting agent including a fatty acid. The invert emulsion drilling fluid included about 1 lb/bbl to about 8 lb/bbl of a liquid fluid loss control agent including a fatty acid ester, e.g., dipropylene glycol methyl ether, and about 0 lb/bbl to about 2 lb/bbl of a rheology modifier including a fatty acid, fatty acid dimer, and a polymer with diethanolamine and diethylenetriamine. The invert emulsion drilling fluid included a weighting agent, e.g., barite, as needed to adjust the density of the invert emulsion drilling fluid. The invert emulsion drilling fluid was formulated as shown in Table 3.

TABLE 3

| Compound | Concentration | |
|---|---|---|
| Diesel | 70 | vol % |
| Lime | 2-10 | lb/bbl |
| Emulsifier Composition | 5-12 | lb/bbl |
| Wetting Agent | 1-4 | lb/bbl |
| Water | 30 | vol % |
| 20-25% WT CaCl2 Brine | | |
| Weighting Agent | As Needed | |
| Fluid Loss Control Agent | 1-8 | lb/bbl |
| Rheology Modifier | 0-2 | lb/bbl |

The rheological properties were measured according to API 13B-2, as shown in Table 4, before heat rolling (Sample 3) and after heat rolling at 200° F. (Sample 4). Fluid tested as per API 13-B2. NAF Solids Analysis is calculated off Diesel 0.835 SG, HDS 4.1 SG, LGS 2.6 SG.

TABLE 4

| Property | Sample 3 | Sample 4 |
|---|---|---|
| Density, ppg | 12.5 at 83° F. | 12.5 at 84° F. |
| Rheology Temp, F. | 150.00 | 150.00 |
| R600/R300 | 56/34 | 42/29 |
| R200/R100 | 26/16 | 24/19 |
| R6/R3 | 9/9 | 11/10 |
| PV, cP | 22 | 13 |
| YP, lbf/100 ft² | 12 | 16 |
| LSYP, lb/100 ft² | 9 | 9 |
| 10-sec Gel, lb/100 ft² | 14 | 10 |
| 10-min Gel, lb/100 ft² | 20 | 11 |
| 30-min Gel, lb/100 ft² | 20 | 12 |
| E.S. Temp, ° F. | 120.00 | 120.00 |
| E.S., V | 241.5 | 427.5 |
| HTHP FL Temp, ° F | 250.00 | 250.00 |
| HTHP Fluid Loss, mL | 1.2 | 3.4 |
| Water in HTHP FL, mL | 0.0 | 0.0 |
| Cake Thickness, 1/32″ | 1.00 | 4.00 |
| Pom, mL | 4.05 | 1.85 |
| Excess Lime, ppb | 5.27 | 2.405 |
| Solids, wt % | 20.25 | 20.00 |
| Oil, vol % | 56.50 | 58.00 |
| Water vol % | 23.25 | 22.00 |
| Oil:Aqueous Phase Ratio | 70.9/29.2 | 72.5/27.5 |
| Cl⁻, whole mud, mg/L | 50,500.00 | 49,500.00 |
| CaCl₂, wt % | 25.99 | 26.04 |
| Aqs Phase Cl⁻, mg/L | 206,091.60 | 206,552.17 |
| Aqs Phase CaCl₂, ppm | 259,940.8 | 260,416.7 |

Each of sample 3 and sample 4 had a fluid density after hot roll and/or while drilling of less than 3 times the plastic viscosity, e.g., R600/R300, thereby indicating a similar density to conventional invert emulsion drilling fluids, which have solid fluid additives. Additionally, each of sample 3 and 4 included a yield point of about 0.8 to about 1.5 times the density after the hot rolling and/or while drilling, thereby indicating capability to suspend drill cuttings while drilling. Each of samples 3 and 4 had a LSYP of greater than or equal to 3 lb/100 ft², thereby indicating a reduced risk of weighting agent sag and a high probability of wellbore cleaning while drilling, compared to conventional drilling fluids. A high temperature high pressure fluid loss at 250° F. was about 1.2 mL for sample 3, and about 3.4 for sample 4, as shown in FIGS. 2A and 2B, thereby indicating reduced instability of a wellbore while drilling, compared to conventional drilling fluids. The filter cake thickness of sample 3 was about 1/32″ and the filter cake thickness of sample 4 was about ⅛″, as shown in FIGS. 2A and 2B, thereby indicating a reduced risk of the drill string or casing/liner string being stuck in the wellbore. Each of samples 3 and 4 included about 0 mL of water in the high temperature high pressure filtrate at 250° F., thereby indicating stability of the invert emulsion drilling fluid

Overall, the present disclosure provides invert emulsion drilling fluids having a stable and optimal rheology for the suspension of weighting material as well as hole cleaning without the use of any clay-based materials and/or insoluble solid components. Elimination of clay-based materials and/or insoluble solid components provides an invert emulsion drilling fluid having reduced pressure downhole, thereby reducing mechanical washout and/or erosion tendency of oilfield tubulars downhole and/or pumping equipment on the surface.

While the foregoing is directed to embodiments of the present invention, other and further embodiments of the present disclosure may be devised without departing from the basic scope thereof, and the scope thereof is determined by the claims that follow.

What is claimed is:

1. A drilling fluid comprising an emulsion, the emulsion comprising:
an aqueous phase;
an oil;
an emulsifier composition comprising an amidoamine; and
a wetting agent comprising:
a first organic acid selected from the group consisting of C₆-C₃₀ carboxylic acid, C₆-C₃₀ alkeynl acid, C₆-C₃₀ arylakyl acid, and a C₆-C₃₀ cycloalkyl acid; and
an alcohol alkoxylate,
wherein a ratio of the oil to the aqueous phase is about 85:15 to about 60:40 of the oil to the aqueous phase.

2. The drilling fluid of claim 1, wherein the emulsifier composition further comprises:
a second organic acid selected from the group consisting of C₆-C₃₀ carboxylic acid, C₆-C₃₀ alkeynl acid, C₆-C₃₀ arylakyl acid, and a C₆-C₃₀ cycloalkyl acid;
an organic acid dimer;
an alkyl ether; and
a paraffin.

3. The drilling fluid of claim 1, wherein the first organic acid is a C₆-C₃₀ carboxylic acid having a formula represented by: 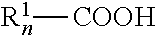
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof; and
n is an integer of 1 to 6.

4. The drilling fluid of claim 1, wherein the alcohol alkoxylate has a formula represented by: 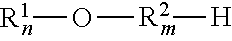
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof;
R² is an C₁-C₃ alkoxy;
n is an integer of 1 to 6; and
m is an integer of 1 to 6.

5. The drilling fluid of claim 1, wherein the drilling fluid further comprises a solid fluid loss control agent, and wherein the solid fluid loss control agent comprises gilsonite.

6. The drilling fluid of claim 5, wherein the drilling fluid comprises:
about 5 pounds per barrel (lbs/bbl) to about 12 lbs/bbl of the emulsifier composition;
about 1 lbs/bbl to about 4 lbs/bbl of the wetting agent; and
about 1 lbs/bbl to about 6 lbs/bbl of the solid fluid loss control agent.

7. The drilling fluid of claim 1, wherein the drilling fluid comprises a liquid fluid loss control additive, and wherein the liquid fluid loss control additive comprises a C₂-C₁₀ fatty acid ether.

8. The drilling fluid of claim 7, wherein the drilling fluid comprises:
about 5 pounds per barrel (lbs/bbl) to about 12 lbs/bbl of the emulsifier composition;
about 1 lbs/bbl to about 4 lbs/bbl of the wetting agent; and
about 1 lbs/bbl to about 8 lbs/bbl of the liquid fluid loss control additive.

9. A drilling fluid comprising an emulsion, the emulsion comprising:
an aqueous phase;
an oil;
a solid fluid loss control agent;
an emulsifier composition comprising an amidoamine; and
a wetting agent comprising a first organic acid;
wherein a ratio of the oil to the aqueous phase is about 85:15 to about 60:40 of the oil to the aqueous phase.

10. The drilling fluid of claim 9, wherein the solid fluid loss control agent comprises gilsonite.

11. The drilling fluid of claim 9, wherein the first organic acid is a C₆-C₃₀ carboxylic acid having a formula represented by: 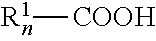
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof; and
n is an integer of 1 to 6.

12. The drilling fluid of claim 9, wherein the emulsifier composition further comprises:
a second organic acid selected from the group consisting of C₆-C₃₀ carboxylic acid, C₆-C₃₀ alkeynl acid, C₆-C₃₀ arylakyl acid, and a C₆-C₃₀ cycloalkyl acid;
an organic acid dimer;
an alkyl ether; and
a paraffin.

13. The drilling fluid of claim 9, wherein the wetting agent further comprise an alcohol alkoxylate having a formula represented by: 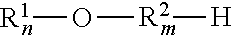
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof;
R² is an C₁-C₃ alkoxy;
n is an integer of 1 to 6; and
m is an integer of 1 to 6.

14. The drilling fluid of claim 9, wherein the drilling fluid comprises:
about 5 pounds per barrel (lbs/bbl) to about 12 lbs/bbl of the emulsifier composition;
about 1 lbs/bbl to about 4 lbs/bbl of the wetting agent; and
about 1 lbs/bbl to about 6 lbs/bbl of the solid fluid loss control agent.

15. A drilling fluid comprising an emulsion, the emulsion comprising:
an aqueous phase;
an oil;
a liquid fluid loss control additive;
an emulsifier composition comprising an amidoamine; and
a wetting agent comprising a first organic acid;
wherein a ratio of the oil to the aqueous phase is about 85:15 to about 60:40 of the oil to the aqueous phase.

16. The drilling fluid of claim 15, wherein the liquid fluid loss control additive comprises a C₂-C₁₀ fatty acid ether.

17. The drilling fluid of claim 15, wherein the first organic acid is a C₆-C₃₀ carboxylic acid having a formula represented by: 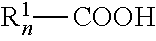
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof; and
n is an integer of 1 to 6.

18. The drilling fluid of claim 15, wherein the emulsifier composition further comprises:
a second organic acid selected from the group consisting of C₆-C₃₀ carboxylic acid, C₆-C₃₀ alkeynl acid, C₆-C₃₀ arylakyl acid, and a C₆-C₃₀ cycloalkyl acid;
an organic acid dimer;
an alkyl ether; and
a paraffin.

19. The drilling fluid of claim 15, wherein the wetting agent further comprise an alcohol alkoxylate having a formula represented by: 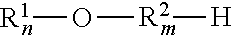
wherein R¹ is a linear or branched carbon chain selected from the group consisting of a substituted C₁-C₃₀ alkyl, an unsubstituted C₁-C₃₀ alkyl, a substituted C₁-C₃₀ alkylene, an unsubstituted C₁-C₃₀ alkylene, substituted C₁-C₃₀ alkynl, an unsubstituted C₁-C₃₀ alkynl, substituted C₁-C₃₀ alkynlene, an unsubstituted C₁-C₃₀ alkynlene, substituted C₁-C₃₀ aryl, an unsubstituted C₁-C₃₀ aryl, a substituted C₁-C₃₀ alkoxy, an unsubstituted C₁-C₃₀ alkoxy, and combinations thereof;
R² is an C₁-C₃ alkoxy;
n is an integer of 1 to 6; and
m is an integer of 1 to 6.

20. The drilling fluid of claim 15, wherein the drilling fluid comprises:
about 5 pounds per barrel (lbs/bbl) to about 12 lbs/bbl of the emulsifier composition;
about 1 lbs/bbl to about 4 lbs/bbl of the wetting agent; and
about 1 lbs/bbl to about 8 lbs/bbl of the liquid fluid loss control additive.
